(19) United States
(12) Patent Application Publication
(10) Pub. No.: US 2009/0083021 A1
(43) Pub. Date: Mar. 26, 2009

(54) EMULATION OF AHCI-BASED SOLID STATE DRIVE USING NAND INTERFACE

(76) Inventors: Chai Huat Gan, Bukit Mertajam (MY); Siang Lin Tan, Bayan Lepas (MY)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/861,170

(22) Filed: Sep. 25, 2007

(51) Int. Cl. G06F 9/455

(52) U.S. Cl. 703/24

(57) ABSTRACT

A device, method, and system are disclosed. In one embodiment, the device includes an emulator to facilitate direct communication between an advanced host controller interface (AHCI) software driver and NAND host controller interface (HCI) hardware.

### FIELD OF THE INVENTION

This invention relates to using emulation to allow an AHCI software driver to be utilized to operate a NAND storage device.

### BACKGROUND OF THE INVENTION

AHCI (Advanced Host Controller Interface) is a host controller interface designed for Serial Advanced Technology Attachment (SATA). The AHCI Specification utilized from Intel® Corporation is the Serial ATA AHCI 1.0 Specification. Generally, an AHCI software driver communicates with a SATA-based storage device coupled to the AHCI Port Controller through a given port. In many embodiments, the AHCI software driver is stored within system memory in the computer system. Most communication between software and a SATA storage device utilizes system memory descriptors stored within system memory. There are multiple descriptors per SATA port that are used to convey information. One is the device frame information structure (FIS) descriptor, which contains FISes received from a SATA device. Another descriptor is the Command List, which contains a list of commands available for a port to execute. Another descriptor is the host FIS, which contains command information to send to the SATA device.

For AHCI, communication between a device and an AHCI software driver moves from the task file via byte-wide accesses in ATA to a command FIS located in system memory that is fetched by the AHCI Port Controller. AHCI is defined to keep the AHCI Port Controller relatively simple so that it can act as a data mover. All data transfers between a SATA storage device and system memory occur through the AHCI Port Controller acting as a bus master to system memory.

NAND Storage Devices are quickly becoming a popular option for safely storing operating system and other computer system information through power downs. A number of computer systems implement a NAND Storage Device that is accessed by software and hardware in the computer system through a NAND Controller. Typically, the NAND Controller is an integrated or discrete controller coupled to an I/O Controller Hub (a portion of a computer system's chipset). As NAND Storage Devices grow in storage size, they are beginning to potentially replace, or at least complement, the storage capacity on a SATA storage device. Generally, the functional commands that control a NAND device are substantially different from the commands that control a SATA device.

### BRIEF DESCRIPTION OF THE DRAWINGS

The present invention is illustrated by way of example and is not limited by the drawings, in which like references indicate similar elements, and in which:

FIG. 1 describes one embodiment of a computer system that includes an Advanced Host Controller Interface (AHCI) Port Controller and a NAND flash device.

FIG. 2 provides one embodiment of a system that enables an AHCI software driver to communicate directly to a NAND storage device through an emulator.

FIG. 3 is a flow diagram of one embodiment of a process to convert an AHCI command, sent from an AHCI software driver, to a NAND HCI command and sending the converted command to a NAND storage device.

FIG. 4 is a flow diagram of one embodiment of a process to convert a NAND status result, sent from a NAND storage device, to an AHCI status result and sending the converted status to an AHCI software driver.

FIG. 5 is a flow diagram of one embodiment of a process to send an AHCI status result to an AHCI software driver in response to a command sent from the AHCI software driver without sending the command to a NAND storage device.

FIG. 6 is a flow diagram of one embodiment of a process to send data and an AHCI status result to an AHCI software driver in response to a command sent from the AHCI software driver without sending the command to a NAND storage device.

FIG. 7 is a flow diagram of one embodiment of a process to send an AHCI status result to an AHCI software driver in response to a command and data sent from the AHCI software driver without sending the command or data to a NAND storage device.

### DETAILED DESCRIPTION OF THE INVENTION

Embodiments of a device, method, and system to emulate a SATA device for an AHCI software driver are described. In the following description, numerous specific details are set forth. However, it is understood that embodiments may be practiced without these specific details. In other instances, well-known elements, specifications, and protocols have not been discussed in detail in order to avoid obscuring the present invention.

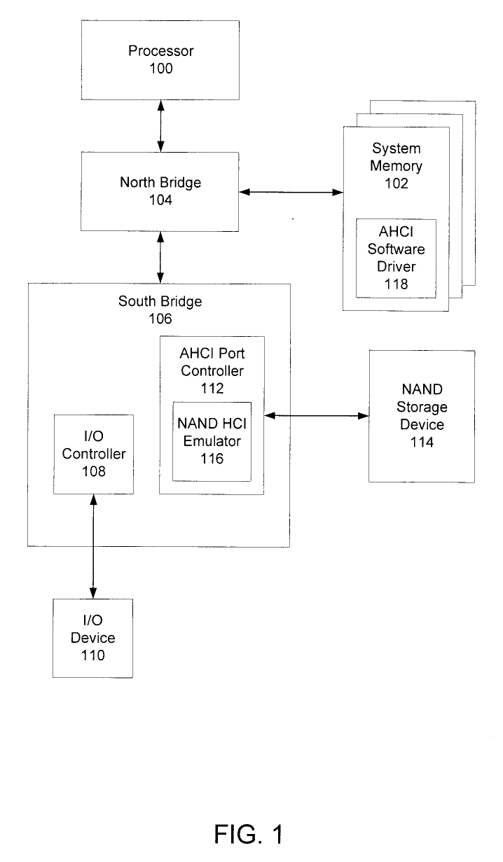

FIG. 1 describes one embodiment of a computer system that includes an Advanced Host Controller Interface (AHCI) Port Controller and a NAND flash device. In many embodiments, the computer system includes one or more processors 100. Each processor may have a single core or may have multiple cores. The computer system also includes a chipset and system memory 102 in many embodiments. The chipset may include a North Bridge 104 that has an integrated memory controller (not shown) in some embodiments. In other embodiments, one or more memory controllers are integrated into one or more of the processors in the computer system. Additionally, in many embodiments, the chipset also may include an input/output (I/O) controller hub, sometimes referred to as a South Bridge 106. The South Bridge 106 may have one or more integrated I/O controllers, such as I/O controller 108, to manage communication across one or more I/O interconnects (busses) in the computer system. Each interconnect provides a path for data to flow between a device coupled to the interconnect, such as I/O Device 110, and other components in the computer system, such as the processor, memory, etc.

In many embodiments, an AHCI Port Controller 112 is located within the South Bridge 106. A NAND flash storage device 114 is also located in the computer system, in many embodiments. Although the AHCI Port Controller 112 normally controls SATA devices attached to one or more ports, the AHCI Port Controller 112 includes a NAND HCI Emulator 116 that emulates a SATA device in the place of the coupled NAND storage device 114 for an AHCI Software Driver 118 located in System Memory 102. Thus, the AHCI Software Driver 118 believes it is communicating with a SATA storage device, when it actually is communicating with NAND Storage Device 114.

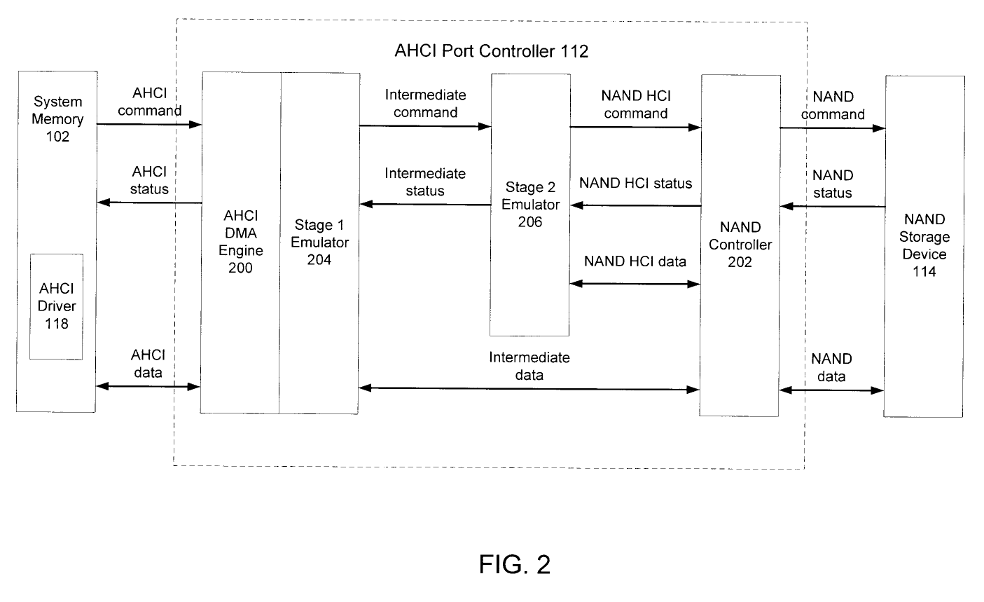

FIG. 2 provides one embodiment of a system that enables an AHCI software driver to communicate directly to a NAND storage device through an emulator. In FIG. 2, the AHCI Port Controller 112 is coupled to both system memory 102, where the AHCI Software Driver 118 is stored and operates from, and to the NAND Flash Storage Device 114. The AHCI Software Driver 118 communicates with the NAND Storage Device 114 through a series of components within the AHCI Port Controller 112. Data is transferred between the AHCI Port Controller 112 and System Memory 102 through an AHCI Direct Memory Access (DMA) Engine 200 located within the AHCI Port Controller 112. The NAND flash device is coupled to the AHCI Port Controller through a NAND Controller 202 embedded within the AHCI Port Controller 112, in many embodiments.

In many embodiments, there is a two-stage emulator located within the AHCI Port Controller 112. The Stage 1 Emulator 204 is coupled to the AHCI DMA Engine 200 and the Stage 2 Emulator 206 is located between the AHCI DMA Engine 200 and the NAND Controller 202. The two-stage emulator accomplishes multiple functions, including: converting an AHCI command into a NAND HCI command, converting a NAND HCI status into an AHCI status, handling any AHCI command that is not applicable to the NAND HCI, converting AHCI data into an intermediate data format, converting NAND HCI data into the intermediate data format, and performing a SATA initialization and a SATA software reset.

Using the above listed functions, the two-stage emulator is capable of emulating any command initiated by the AHCI Software Driver 118. These commands include a data read from SATA (such as a PIO read or a DMA read), a data write to SATA (such as a PIO write or a DMA write), a non-data command to SATA (such as Execute Device Diagnostic), a data command specific to SATA that is not applicable to the NAND HCI (such as Identify Device), a SATA Software Reset command, or a SATA Initialization Request. The specific functionality of each emulator stage is described in detail below in relationship to the above listed commands.

In some embodiments, during a PIO Write command, the AHCI DMA Engine 200 fetches the AHCI command from system memory. As described in the AHCI specification, the AHCI command from system memory consists of a Command Header and a Command FIS. After retrieval, the Stage 1 Emulator 204 combines the Command Header and Command FIS into an intermediate command. The intermediate command consists of the AHCI PIO Write command in an intermediate format that is sent from the Stage 1 Emulator 204 to the Stage 2 Emulator 206. The Stage 2 Emulator 206, which is capable of reading the intermediate command format, receives the intermediate command and translates the intermediate command into a “Data Write to NAND” command that is compatible with the NAND Controller 202. The NAND Controller 202 fetches the NAND-compatible command and then sends the command to the NAND Storage Device 114.

Additionally, with an AHCI PIO Write command, the data to be written is fetched from system memory. Once the AHCI DMA Engine 200 has the data from system memory to write, the Stage 1 Emulator 204 converts the data to an intermediate data format that is compatible with the NAND Controller 202. The NAND Controller 202 receives the intermediate data from the Stage 1 Emulator 204. The NAND Controller 202 then translates the intermediate data into NAND storage device compatible data, and sends the translated NAND data to the NAND Storage Device 114 for the write operation.

Upon completion of the data transfer, status information from the NAND flash storage device 114 is sent to the NAND Controller 202, which is then further sent to the Stage 2 Emulator 206. The Stage 2 Emulator 206 then translates the status information into an intermediate status that consists of a PIO Setup FIS and a Device to Host (D2H) Register FIS, which, in this form, is sent by the Stage 2 Emulator 206 to the Stage 1 Emulator 204. The PIO Setup FIS and D2H Register FIS are described in detail in the AHCI specification. The Stage 1 Emulator 204 then breaks the intermediate status into the two separate FISes (the PIO Setup FIS and the D2H Register FIS) and passes these two FISes to the AHCI DMA Engine 200, which, in turn, posts the two FISes to System Memory 102. Posting these two FISes to System Memory 102 allows the AHCI Software Driver 118 to operate as if the FISes are from a SATA device rather than from the NAND Storage Device 114 that is actually present. This completes the PIO Write transaction.

In some example embodiments, during a DMA Write command, the AHCI DMA Engine 200 fetches the AHCI command from System Memory 102. After retrieval, the Stage 1 Emulator 204 combines the Command Header and Command FIS into an intermediate command. The intermediate command consists of the AHCI DMA Write command in an intermediate format that is sent from the Stage 1 Emulator 204 to the Stage 2 Emulator 206. The Stage 2 Emulator 206, which is capable of reading the intermediate command format, receives the intermediate command and translates the intermediate command into a “Data Write to NAND” command that is compatible with the NAND Controller 202. The NAND Controller 202 fetches the NAND-compatible command and then sends the command to the NAND Storage Device 114.

Additionally, with an AHCI DMA Write command, the data to be written is fetched from system memory. After the AHCI DMA Engine 200 fetches the data from System Memory 102 to write, the Stage 1 Emulator 204 converts the data to an intermediate data format that is compatible with the NAND Controller 202. The NAND Controller 202 receives the intermediate data from the Stage 1 Emulator 204 and translates the intermediate data into NAND Storage Device 114 compatible data, and sends the translated NAND data to the NAND Storage Device 114 for the write operation.

Once all of the data has been transferred from the DMA Write command, status information from the NAND flash storage device 114 is sent to NAND Controller 202, which is then further sent to Stage 2 Emulator 206. The Stage 2 Emulator 206 then translates the status information into an intermediate status that consists of a Device to Host (D2H) Register FIS, which, in this form, is sent by the Stage 2 Emulator 206 to the Stage 1 Emulator 204. The Stage 1 Emulator 204 then takes the D2H Register FIS in the intermediate status and passes it to the AHCI DMA Engine 200, which, in turn, posts the D2H Register FIS to System Memory 102. This completes the DMA Write transaction.

Similarly, the two-stage emulator can also emulate read transactions. In some embodiments, during a PIO read command, the AHCI DMA Engine 200 fetches the AHCI command from System Memory 102. After retrieval, the Stage 1 Emulator 204 combines the Command Header and Command FIS into an intermediate command. The intermediate command consists of the AHCI PIO Read command in an intermediate format that is sent from the Stage 1 Emulator 204 to the Stage 2 Emulator 206. The Stage 2 Emulator 206, which is capable of reading the intermediate command format, receives the intermediate command and translates the intermediate command into a “Data Read to NAND” command that is compatible with the NAND Controller 202. The NAND Controller 202 fetches the NAND-compatible command and then sends the command to the NAND Storage Device 114.

Once the targeted data from the read command is returned from the NAND Storage Device 114 to the NAND Controller 202, the NAND Controller 202 translates the data into the intermediate data format and sends the intermediate data to the Stage 1 Emulator 204. The Stage 1 Emulator 204 then translates the intermediate data to AHCI-compatible data and transfers the translated data to the AHCI DMA Engine 200. The AHCI DMA Engine 200 then writes the AHCI-compatible data to System Memory 102.

Upon completion of the data transfer, status information from the NAND flash storage device 114 is sent to the NAND Controller 202, which is then further sent to the Stage 2 Emulator 206. The Stage 2 Emulator 206 then translates the status information into an intermediate status that consists of a PIO Setup FIS, which, in this form, is sent by the Stage 2 Emulator 206 to the Stage 1 Emulator 204. The Stage 1 Emulator 204 then takes the PIO Setup FIS in the intermediate status and passes it to the AHCI DMA Engine 200, which then posts the FIS to System Memory 102. Posting these two FISes to System Memory 102 allows the AHCI Software Driver 118 to operate as if the FISes are from a SATA device rather than from the NAND Storage Device 114 that is actually present. This completes the PIO Read transaction.

In some embodiments, during a DMA read command, the AHCI DMA Engine 200 fetches the AHCI command from System Memory 102. After retrieval, the Stage 1 Emulator 204 combines the Command Header and Command FIS into an intermediate command. The intermediate command consists of the AHCI DMA Read command in an intermediate format that is sent from the Stage 1 Emulator 204 to the Stage 2 Emulator 206. The Stage 2 Emulator 206, which is capable of reading the intermediate command format, receives the intermediate command and translates the intermediate command into a “Data Read to NAND” command that is compatible with the NAND Controller 202. The NAND Controller 202 fetches the NAND-compatible command and then sends the command to the NAND Storage Device 114

Once the targeted data from the read command is returned from the NAND Storage Device 114 to the NAND Controller 202, the NAND Controller 202 translates the data into the intermediate data format and sends the intermediate data to the Stage 1 Emulator 204. The Stage 1 Emulator 204 then translates the intermediate data to AHCI-compatible data and transfers the translated data to the AHCI DMA Engine 200. The AHCI DMA Engine 200 then writes the AHCI-compatible data to System Memory 102.

After the final data FIS has been sent from the NAND Storage Device 1 14, status information from the NAND flash storage device 114 is sent to NAND Controller 202, which is then further sent to Stage 2 Emulator 206. The Stage 2 Emulator 206 translates the status information into an intermediate status that consists of a Device to Host (D2H) Register FIS, and sends the intermediate status to the Stage 1 Emulator 204. Once the Stage 1 Emulator 204 receives the intermediate status, it takes the D2H Register FIS from the intermediate status and transfers the FIS to the AHCI DMA Engine 200. Finally, the AHCI DMA Engine 200 writes the D2H Register FIS to System Memory 102 and the DMA read transaction is complete.

In many embodiments, an AHCI command, such as the ones described above, may be mapped to a single NAND HCI command or multiple NAND HCI commands by the Stage 2 Emulator 206. In many embodiments, mapping the AHCI command to multiple NAND HCI commands may happen when the transfer size in the AHCI command is larger than the NAND Storage Device 114 page size. For example, an 8 Kilobyte AHCI command can be broken into two NAND HCI commands, each doing a 4 Kilobyte transfer due to a 4 Kilobyte page size in the NAND Storage Device 114. Thus, in many embodiments, the Stage 2 Emulator 206 has a small command queue to handle situations where one received AHCI command requires being mapped to multiple NAND HCI commands to the NAND Storage Device 114.

In many embodiments, for non-data AHCI commands to SATA, the Stage 2 Emulator 206 will return the D2H Register FIS and complete the command immediately. Thus, a non-data command will not even be seen by the NAND Controller 202. Though, to the AHCI Software Driver 118, it will look like the non-data AHCI command has successfully completed.

The AHCI Software Driver 118 may send an AHCI Software Reset command to the NAND Storage Device 114, in many embodiments. The Software Reset command consists of two Command FISes, specifically two Host-to-Device (H2D) Register FISes. The first H2D Register FIS has the Software Reset bit (SRST bit) set to ‘1’ in the Control field of the Register FIS. The second H2D Register FIS has the SRST bit set to ‘0’ in the Control field of the Register FIS. The Software Reset command is explained in detail in the AHCI Specification. To correctly emulate the Software Reset command, after the Stage 2 Emulator 206 receives the intermediate command consisting of the first of the two H2D Register FISes (with the SRST bit set to ‘1’), the Stage 2 Emulator 206, which is capable of reading the intermediate command format, then immediately returns a dummy intermediate status to the AHCI Software Driver 118 to acknowledge the reception of the first H2D Register FIS. This acknowledgement triggers the AHCI DMA Engine 200 to fetch and send the second H2D Register FIS (with the SRST bit set to ‘0’) to the Stage 2 Emulator 206.

The Stage 2 Emulator 206, which is capable of reading the intermediate command format, generates the required D2H Register FIS. The generated D2H Register FIS has the device signature value to tell the AHCI Software Driver 118 if it is an ATA or ATAPI (AT Attachment Packet Interface) device. The Stage 2 Emulator 206 puts the D2H Register FIS inside the intermediate status, and sends the intermediate status to the Stage 1 Emulator 204. Once the Stage 1 Emulator 204 receives the intermediate status, it takes the D2H Register FIS in the intermediate status and transfers the FIS to the AHCI DMA Engine 200. Finally, the AHCI DMA Engine 200 writes the D2H Register FIS to System Memory 102 and the Software Reset command is complete.

When a command is issued by the AHCI Software Driver 118 that is specific to SATA (i.e. not necessary or compatible with NAND), the Stage 2 Emulator generates or receives data on behalf of the SATA device based on a combination of information gathered from multiple sources, such as from NAND during initialization, or internal lookup. Two examples of this are the Identify Device command, which is a PIO Read command per the ATA Specification, and the Download Microcode command, which is a PIO Write command per the ATA Specification.

During an Identify Device command, the AHCI DMA Engine 200 fetches the AHCI command from System Memory 102. After retrieval, the Stage 1 Emulator 204 combines the Command Header and Command FIS into an intermediate command. The intermediate command consists of the AHCI Identify Device command in an intermediate format that is sent from the Stage 1 Emulator 204 to the Stage 2 Emulator 206. The Stage 2 Emulator 206, which is capable of reading the intermediate command format, receives the intermediate command and translates the intermediate command into an “Emulator Data Write to Software” command that is compatible with the NAND Controller 202. The NAND Controller 202 fetches the NAND HCI command but does not send the command to the NAND Storage Device 114.

Additionally, with the “Emulator Data Write to Software” command, the NAND Controller 202 fetches the Data from the Stage 2 Emulator 206 which is in the NAND HCI Data format. This NAND HCI Data is generated by Stage 2 Emulator 206 that tells AHCI Software Driver 118 various kinds of info of the emulated SATA harddisk such as capabilities, setting etc. Once the targeted data from the “Emulator 2 Data Write to Software” command is returned from the Stage 2 Emulator 206 to the NAND Controller 202, the NAND Controller 202 translates the data into the intermediate data format and sends the intermediate data to the Stage 1 Emulator 204. The Stage 1 Emulator 204 then translates the intermediate data to AHCI-compatible data and transfers the translated data to the AHCI DMA Engine 200. The AHCI DMA Engine 200 then writes the AHCI-compatible data to System Memory 102.

Upon completion of the data transfer, NAND Controller 202 generates the NAND HCI Status, which is then sent to the Stage 2 Emulator 206. The Stage 2 Emulator 206 then translates the status information into an intermediate status that consists of a PIO Setup FIS, which, in this form, is sent by the Stage 2 Emulator 206 to the Stage 1 Emulator 204. The Stage 1 Emulator 204 then takes the PIO Setup FIS in the intermediate status and passes it to the AHCI DMA Engine 200, which, in turn, posts the FIS to System Memory 102. This completes the Identify Device command which follows the PIO Read protocol.

During a Download Microcode command, the AHCI DMA Engine 200 fetches the AHCI command from System Memory 102. After retrieval, the Stage 1 Emulator 204 combines the Command Header and Command FIS into an intermediate command. The intermediate command consists of the AHCI Download Microcode command in an intermediate format that is sent from the Stage 1 Emulator 204 to the Stage 2 Emulator 206. The Stage 2 Emulator 206, which is capable of reading the intermediate command format, receives the intermediate command and translates the intermediate command into an “Emulator Data Read from Software” command that is compatible with the NAND Controller 202. The NAND Controller 202 fetches the NAND HCI command but does not send the command to the NAND Storage Device 114.

Additionally, with the Download Microcode command, the data to be written is fetched from system memory. Once the AHCI DMA Engine 200 has the data from system memory to write, the Stage 1 Emulator 204 converts the data to an intermediate data format that is compatible with the NAND Controller 202. The NAND Controller 202 receives the intermediate data from the Stage 1 Emulator 204. The NAND Controller 202 then translates the intermediate data into NAND HCI Data format, and sends the translated NAND HCI Data format to the Stage 2 Emulator 206.

Upon completion of the data transfer, the NAND Controller 202 generates the NAND HCI Status, which is then sent to the Stage 2 Emulator 206. The Stage 2 Emulator 206 then translates the status information into an intermediate status that consists of a PIO Setup FIS and a Device to Host Register FIS, which, in this form, is sent by the Stage 2 Emulator 206 to the Stage 1 Emulator 204. The Stage 1 Emulator 204 then takes the PIO Setup FIS and Device to Host Register FIS in the intermediate status and passes them to the AHCI DMA Engine 200, which, in turn, posts the FISes to System Memory 102. This completes the Download Mircrocode command which follows the PIO Write protocol.

In many embodiments, when a SATA interface reset is initiated by the AHCI driver, the initialization is emulated. There are several ways AHCI Software Driver 118 can reset the AHCI port. For example, the AHCI Software Driver 118 can set the PxCMD.DET register bit in the AHCI DMA Engine 200 to “1” and then to “0.” When the Stage 1 Emulator 204 detects this toggling event in AHCI DMA Engine 200, Stage 1 Emulator 204 generates the intermediate command consisting of the AHCI port reset command and sends the intermediate command to the Stage 2 Emulator 206. The Stage 2 Emulator 206, which is capable of reading the intermediate command format, generates the required D2H Register FIS. The generated D2H Register FIS has the device signature value to tell AHCI Software Driver 118 if it is an ATA or ATAPI device. Then the Stage 2 Emulator 206 puts the D2H Register FIS inside the intermediate status, and sends the intermediate status to the Stage 1 Emulator 204. Once the Stage 1 Emulator 204 receives the intermediate status, it takes the D2H Register FIS in the intermediate status and transfers the FIS to the AHCI DMA Engine 200. Finally, the AHCI DMA Engine 200 writes the D2H Register FIS to System Memory 102 and the AHCI port reset is complete.

In many embodiments, during system power up, the Stage 1 Emulator emulates the AHCI Port Register value. This includes such information as the negotiated interface speed, device detection, the interface power state, and Taskfile status to complete the port initialization. The information stored within the AHCI Port Register is specified in the AHCI Specification. This emulation is part of the SATA interface reset flow. When the AHCI Software Driver 118 resets the AHCI port interface, the Stage 1 Emulator 204 emulates the value for several AHCI registers in the AHCI DMA Engine 200. For example, the Serial ATA Status (SSTATUS) register may indicate to the AHCI Software Driver 118 that the SATA interface does not currently detect a device device and that physical communication is not established before the AHCI Software Driver 118 enables the port. When the AHCI Software Driver 118 enables the port, the Serial ATA Status register indicates that device presence is detected and that physical communication is established, At this point the interface is active and the speed of the interface has been negotiated (I.e. gen1, gen2 or gen3).

In some embodiments, when a fatal error, such as an unrecoverable ECC error, is encountered on the NAND interface, the fatal error is propagated back to the AHCI Driver with the Taskfile Error bit set in the AHCI Port Status Register. This allows the emulation of the error condition and the AHCI Port Register value as if the AHCI driver is interfacing with a SATA device.

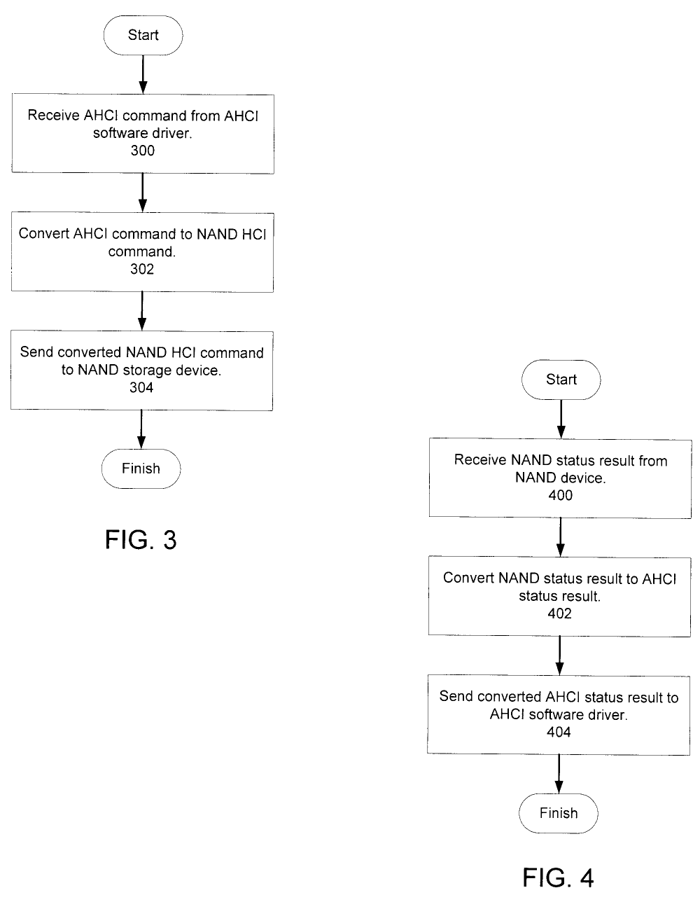

FIGS. 3-7 describe flow diagrams of multiple embodiments of a process to emulate a SATA device for an AHCI software driver. The process flow described below for each of FIG. 3-7 are also described in detail above in the description related to FIG. 2. The process in each of FIGS. 3-7 is performed by processing logic that may comprise hardware (circuitry, dedicated logic, etc.), software (such as is run on a general purpose computer platform or a dedicated machine), or a combination of both.

Referring to FIG. 3, the process begins by processing logic receiving an AHCI command from an AHCI software driver (processing block 300). The process continues with processing logic converting the received AHCI command to a NAND HCI command (processing block 302). Finally, the process concludes with processing logic sending the converted NAND HCI command to a NAND storage device (processing block 304). An example of the process in FIG. 3 is the portion of a PIO Write to NAND of the data being sent from the AHCI software driver and written to the NAND storage device.

In FIG. 4, the process begins by processing logic receiving a NAND status result from a NAND device (processing block 400). In many embodiments, this NAND status result is as a result of the command sent to the NAND storage device in processing block 304. Next, processing logic converts the NAND status result to an AHCI status result (processing block 402). Finally, processing logic sends the converted AHCI status result to the AHCI software driver (processing block 404) and the process is finished. An example of the process in FIG. 3 is the portion of a PIO Write to NAND of the NAND status being returned from the NAND storage device, after the PIO Write takes place, and reaching the AHCI software driver as an AHCI status.

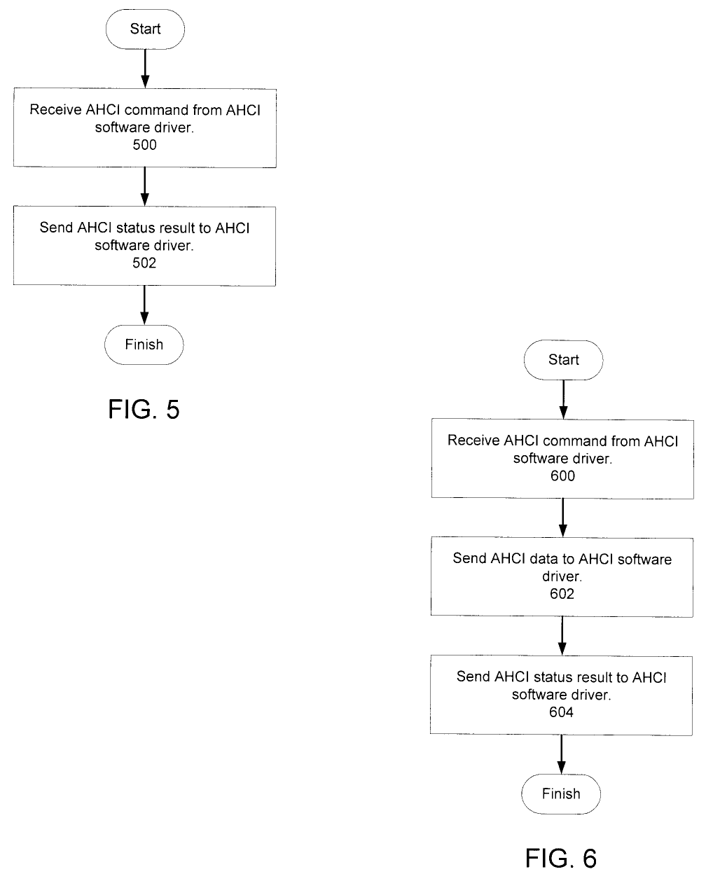

The FIG. 5 process begins by processing logic receiving an AHCI command from the AHCI software driver (processing block 500). Next, as a result of the received command, processing logic sends an AHCI status result to the AHCI software driver (processing block 502) and the process is finished. The FIG. 5 process is different than the combination of the process relating to FIGS. 3 and 4 in that the FIG. 5 process never reaches the NAND storage device, rather the process is contained in the interaction between the AHCI software driver and the Emulator processing logic. An example of the process shown in FIG. 5 is a SATA Initialization request originating from the AHCI software driver.

In FIG. 6, the process begins by processing logic receiving an AHCI command from the AHCI software driver (processing block 600). Next, as a result of the received command, processing logic sends AHCI data to the AHCI software driver (processing block 602). Then processing logic sends the AHCI status result to the AHCI software driver (processing block 604) and the process is finished. An example of the process shown in FIG. 6 is a SATA Identify Device request originating from the AHCI software driver.

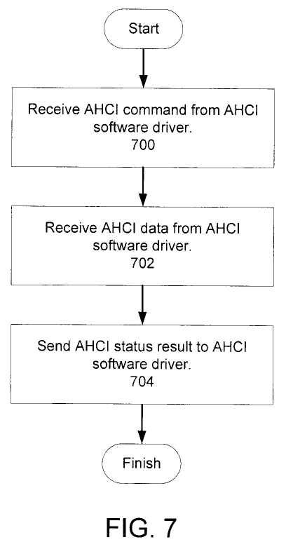

Finally, in FIG. 7, the process begins by processing logic receiving an AHCI command from the AHCI software driver (processing block 700). Next, processing logic receives AHCI data from the AHCI software driver (processing block 702). Then processing logic sends the AHCI status result to the AHCI software driver (processing block 704) and the process is finished. An example of the process shown in FIG. 7 is the Download Microcode command originating from the AHCI software driver.

Thus, embodiments of a device, method, and system Embodiments of a device, method, and system to emulate a SATA device for an AHCI software driver are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A method, comprising:
emulating a serial advanced technology attachment (SATA) interface in the place of a NAND storage device for an AHCI software driver.

2. The method of claim 1, further comprising
receiving an AHCI command from the AHCI software driver directed to the SATA interface;
converting the AHCI command to a NAND HCI command; and
sending the converted NAND HCI command to the NAND storage device.

3. The method of claim 1, further comprising:
receiving a NAND HCI status result from the NAND storage device;
converting the NAND HCI status result to an AHCI status result;
sending the converted AHCI status result to the AHCI software driver.

4. The method of claim 1, further comprising:
receiving an AHCI command from the AHCI software driver directed to the SATA interface; and
sending an AHCI status result to the AHCI software driver in response to receiving the AHCI command.

5. The method of claim 1, further comprising:
receiving an AHCI command from the AHCI software driver directed to the SATA interface;
sending data to the AHCI software driver in response to receiving the AHCI command; and
sending an AHCI status result to the AHCI software driver in response to receiving the AHCI command.

6. The method of claim 1, further comprising:
receiving an AHCI command from the AHCI software driver directed to the SATA interface;
receiving data from the AHCI software driver directed to the SATA interface; and
sending an AHCI status result to the AHCI software driver in response to receiving the AHCI command and the data.

7. The method of claim 1, further comprising converting one of AHCI-compatible data to NAND HCI-compatible data and NAND HCI-compatible data to AHCI-compatible data.

8. A device, comprising an emulator to:
emulate a serial advanced technology attachment (SATA) interface in the place of a NAND storage device for an AHCI software driver.

9. The device of claim 8, wherein the emulator is further operable to:
receive an AHCI command from the AHCI software driver directed to the SATA interface;
convert the AHCI command to a NAND HCI command; and
send the converted NAND HCI command to the NAND storage device.

10. The device of claim 8, wherein the emulator is further operable to:
receive a NAND HCI status result from the NAND storage device;
convert the NAND HCI status result to an AHCI status result;
send the converted AHCI status result to the AHCI software driver.

11. The device of claim 8, wherein the emulator is further operable to:
receive an AHCI command from the AHCI software driver directed to the SATA interface; and
send an AHCI status result to the AHCI software driver in response to receiving the AHCI command.

12. The device of claim 8, wherein the emulator is further operable to:
receive an AHCI command from the AHCI software driver directed to the SATA interface;
send data to the AHCI software driver in response to receiving the AHCI command; and
send an AHCI status result to the AHCI software driver in response to receiving the AHCI command.

13. The device of claim 8, wherein the emulator is further operable to:
receive an AHCI command from the AHCI software driver directed to the SATA interface;
receive data from the AHCI software driver directed to the SATA interface; and
send an AHCI status result to the AHCI software driver in response to receiving the AHCI command and the data.

14. The device of claim 8, wherein the emulator is further operable to convert one of AHCI-compatible data to NAND HCI-compatible data and NAND HCI-compatible data to AHCI-compatible data.

15. A system, comprising:
a memory to store an advanced host controller interface (AHCI) software driver;
a NAND storage device;
a NAND host controller interface (HCI) coupled to the NAND storage device; and
an emulator, coupled to the NAND HCI, to facilitate direct communication between the AHCI software driver and the NAND HCI.

16. The system of claim 15, wherein the emulator is further operable to:
receive an AHCI command from the AHCI software driver directed to the SATA interface;
convert the AHCI command to a NAND HCI command; and
send the converted NAND HCI command to the NAND storage device.

17. The system of claim 15, wherein the emulator is further operable to:
receive a NAND HCI status result from the NAND storage device;
convert the NAND HCI status result to an AHCI status result;
send the converted AHCI status result to the AHCI software driver.

18. The system of claim 15, wherein the emulator is further operable to:
receive an AHCI command from the AHCI software driver directed to the SATA interface; and
send an AHCI status result to the AHCI software driver in response to receiving the AHCI command.

19. The system of claim 15, wherein the emulator is further operable to:
receive an AHCI command from the AHCI software driver directed to the SATA interface;
send data to the AHCI software driver in response to receiving the AHCI command; and
send an AHCI status result to the AHCI software driver in response to receiving the AHCI command.

20. The system of claim 15, wherein the emulator is further operable to:
receive an AHCI command from the AHCI software driver directed to the SATA interface;
receive data from the AHCI software driver directed to the SATA interface; and
send an AHCI status result to the AHCI software driver in response to receiving the AHCI command and the data.
